(19) United States
(12) Patent Application Publication
(10) Pub. No.: US 2026/0057801 A1
(43) Pub. Date: Feb. 26, 2026

(54) PRACTICE DEVICE FOR VIOLIN FINGERING

(71) Applicant: Shandong Normal University, Jinan (CN)

(72) Inventor: Yang Li, Jinan (CN)

(21) Appl. No.: 18/810,444

(22) Filed: Aug. 20, 2024

(51) Int. Cl. G09B 15/06; G10D 1/02

(52) U.S. Cl. CPC G09B 15/06; G10D 1/02

(57) ABSTRACT

The present disclosure relates to the technical field of violins, and in particular, to a practice device for violin fingering. Aiming at the problems of being unable to accurately determine the accuracy of practices and deepen fingering memory by reviewing the fingering for a violin, in the present disclosure, when fingertips press finger pressing grooves of pressing cylinders, light strips of the pressing cylinders illuminate, and as the pressing strength increases, colors of the light strips deepen and light becomes bright; and a camera records bending angles of fingers, and a recording box records the sound of pressing and knocking strength of the fingers, to help a practicer observe the force-generating state of fingers later, and perform targeted practices.

### TECHNICAL FIELD

The present disclosure relates to the technical field of violins, and in particular to a practice device for violin fingering.

### BACKGROUND

A violin is a stringed instrument with four strings, which generates vibration by the friction between strings and a bow, and transmits the vibration to a backboard through column speakers in a resonant tank (body), and the resonance generated by these parts generates a harmonious and bright violin sound. The violin is widely spread around the world and is the most important instrument in a string group of a modern orchestra. It occupies a very important position in instrumental music, is the pillar of modern symphony orchestra, and is also a solo instrument with high difficulty playing skills, known as the world's three major instruments with piano and classical guitar. In a process of violin learning, it is necessary to rely on fingers to press the strings to determine intonations, but because there is no mark on a violin's fingerboard, a player cannot clearly find actual positions of notes to be played on the fingerboard, resulting in confusion of fingering. Therefore, for beginners, violin learners with certain experience, and learners at an advanced level, it is one of the important and difficult technologies to determine the position of notes on the fingerboard, which is a complicated process involving thinking activities and listening to the sound source. It is too difficult, inefficient and slow for learners to remember the sound corresponding to each note accurately. Therefore, a practice device for violin fingering is provided.

After searching, a practice device for violin fingering is disclosed in a patent with a publication number of CN 109410695 B, which aims to solve the technical problems that learners can't be guaranteed to practice finger strength, can't feel the change of fingertip strength intuitively, can't restore a real scene of violin playing, and can't help the learners develop good practice habits. Moreover, due to different sizes of violins used by people of different ages, the practice device cannot be adjusted as needed. Strings are fixed on an upper part of a fingerboard by an upper fixing shaft and a lower fixing shaft, and supported by elastic blocks, so that the learners can develop a good habit of pressing strings while memorizing the musical alphabets, ensuring the effect of practice. The tension of strings can be adjusted freely by adjusting a knob, which can meet the different needs of learners; and a connecting column arranged at a lower part of the elastic block is fixed with a pressure spring through a support plate, which can increase the finger strength practice of learners.

However, the following disadvantages still need to be solved: in practice, the user focuses on the adjustment and practice of fingers, and cannot accurately determine the accuracy of practice and deepen fingering memory by reviewing the fingering for the violin.

### SUMMARY

The present disclosure provides a practice device for violin fingering on the basis of the existing technical problems of being unable to accurately determine the accuracy of practices and deepen fingering memory by reviewing the fingering for a violin.

The present disclosure provides a practice device for violin fingering, including a base. A first adhesive sheet and a second adhesive sheet are rotatably mounted on two sides of a bottom end of the base, and an outer cover is inserted at a top end of the base; the top end of the base is disposed with sockets in a rectangular array, and a buffer cover is inserted at a top end of each of the sockets; a connector and a pressure sensor are fixedly mounted in a middle of an inner wall of a bottom end of the buffer cover, a support column is slidably mounted at an interior of the buffer cover, and a top end of the support column is fixedly connected to a limiting plate; a pressing cylinder is fixedly mounted at a top end of the limiting plate, and a top end of the pressing cylinder is arranged with a finger pressing groove; an annular opening is disposed at an upper end of a circumference of the pressing cylinder, a control box is placed at an interior of the pressing cylinder, a light strip is wound around a circumference of the annular opening, and the light strip is electrically connected to the control box via a wire; and an outer wall of the outer cover is sprayed with a magnetic coating, a recording box is magnetically sucked on an outer wall of one end of the outer cover, a camera is magnetically sucked on an outer wall of one side of the outer cover, a plurality of through holes are disposed on a top end of the outer cover, and centers of the through holes and the sockets in each row are located on the same straight line.

Preferably, rectangular grooves are disposed on two sides of the top end of the base, rectangular sheets are fixedly connected to two sides of a bottom end of the outer cover, and the rectangular sheet on each side is inserted into the rectangular groove.

Preferably, a sliding groove is disposed at a middle and upper end of an outer wall of the other end of the outer cover, and sliding blocks are slidably mounted on two sides of an interior of the sliding groove; and guide rods are rotatably mounted at the other ends of the two sliding blocks, and a mounting frame is rotatably arranged at terminal ends of the two guide rods, an outer side of the mounting frame being made of a rubber material.

Preferably, an inserting column is fixedly connected to the bottom end of the buffer cover, four corners of the buffer cover are rounded, and rubber columns are fixedly mounted at four corners of the bottom end of the buffer cover.

Preferably, a pressing block is fixedly connected to a bottom end of the support column, and four corners of the pressing block are slidably sleeved with four corners of an inner wall of the buffer cover; and a plurality of elastic rods with equal angles are fixedly and obliquely mounted between a bottom end of the pressing block and an inner wall of the bottom end of the buffer cover, and the four rubber columns are all located at bottom ends of the four corners of the pressing block.

Preferably, a diameter of the limiting plate is large than that of the through hole, and the diameter of the through hole is slightly larger than that of the pressing cylinder.

Preferably, a top end of the finger pressing groove is rounded, and the finger pressing groove is sprayed with a matte coating.

Preferably, an interior of the control box is arranged with a control module, a Bluetooth module, a power module and a storage module.

Preferably, the light strip is arranged with a light color change and a light intensity gradient.

The present disclosure has the following beneficial effects.

1. According to the practice device for violin fingering provided by the present disclosure, the buffer covers, the pressing cylinders and the outer cover are arranged at the top end of the base, and lower ends of circumferences of the pressing cylinders are located at top ends of the buffer covers. Before performing violin fingering practice, firstly, the practice content of fingering is confirmed, and the base is fixed on the violin through the first adhesive sheet and the second adhesive sheet; sequentially, the split practice of two adjacent fingers is performed; and finally, the recording box and the camera are magnetically attracted to appropriate positions of the outer cover, and the violin fingering practice is performed. Moreover, the light strips are arranged at the circumferences of the pressing cylinders, and the light strip is arranged with a light color change and a light intensity gradient. The interior of the control box is arranged with the control module, the Bluetooth module, the power module and the storage module. When fingertips press the finger pressing grooves of the pressing cylinders, the light strips of the pressing cylinders illuminate, and as the pressing strength increases, colors of the light strips deepen and light becomes bright; and the camera records bending angles of fingers, and the recording box records the sound of pressing and knocking strength of the fingers, to help the practicer observe the force-generating state of fingers later, and perform targeted practice. If fingering practice is not performed according to an order of practice content or a practice error occurs, a light strip of a pressing cylinder which is not to be pressed sends a warning light.

2. According to the practice device for violin fingering provided by the present disclosure, the magnetic coating is sprayed on the outer wall of the outer cover, the recording box is magnetically absorbed on the outer wall of one end of the outer cover, and the camera is magnetically absorbed on the outer wall of one side of the outer cover. Positions of the recording box and the camera on the outer wall of the outer cover can be adjusted according to requirements. The sliding groove is disposed at the middle and upper end of the outer wall of the other end of the outer cover, and the sliding blocks are slidably mounted on the two sides of the interior of the sliding groove; and the guide rods are rotatably mounted at the other ends of the two sliding blocks, and the mounting frame is rotatably arranged at the terminal ends of the two guide rods. In this way, the camera can be placed on the mounting frame, and the mounting frame can be pulled away from the outer cover, so that the camera can more clearly photograph the force-generating state and positions of fingers when performing violin fingering practice. The outer side of the mounting frame is made of a rubber material, so that the mounting frame can be deformed, and two adjacent fingers can be split for practice.

### BRIEF DESCRIPTION OF THE DRAWINGS

FIG. 1 is a schematic structural diagram of a practice device for violin fingering according to the present disclosure;

FIG. 2 is a schematic structural diagram of a base of the practice device for violin fingering according to the present disclosure;

FIG. 3 is a schematic structural diagram of an outer cover of the practice device for violin fingering according to the present disclosure;

FIG. 4 is a schematic structural diagram of a buffer cover of the practice device for violin fingering according to the present disclosure;

FIG. 5 is a schematic structural diagram of a light strip of the practice device for violin fingering according to the present disclosure;

FIG. 6 is a schematic structural diagram of a pressing block of the practice device for violin fingering according to the present disclosure; and

FIG. 7 is a control diagram of a control box of the practice device for violin fingering according to the present disclosure.

Reference numerals and denotations thereof: 1-base, 2-first adhesive sheet, 3-second adhesive sheet, 4-rectangular groove, 5-outer cover, 6-socket, 7-buffer cover, 8-rectangular sheet, 9-through hole, 10-recording box, 11-sliding groove, 12-sliding block, 13-guide rod, 14-mounting frame, 15-camera, 16-inserting column, 17-support column, 18-limiting plate, 19-pressing cylinder, 20-finger pressing groove, 21-annular opening, 22-light strip, 23-control box, 24-pressing block, 25-elastic rod, 26-rubber column, 27-connector, and 28-pressure sensor.

### DETAILED DESCRIPTION

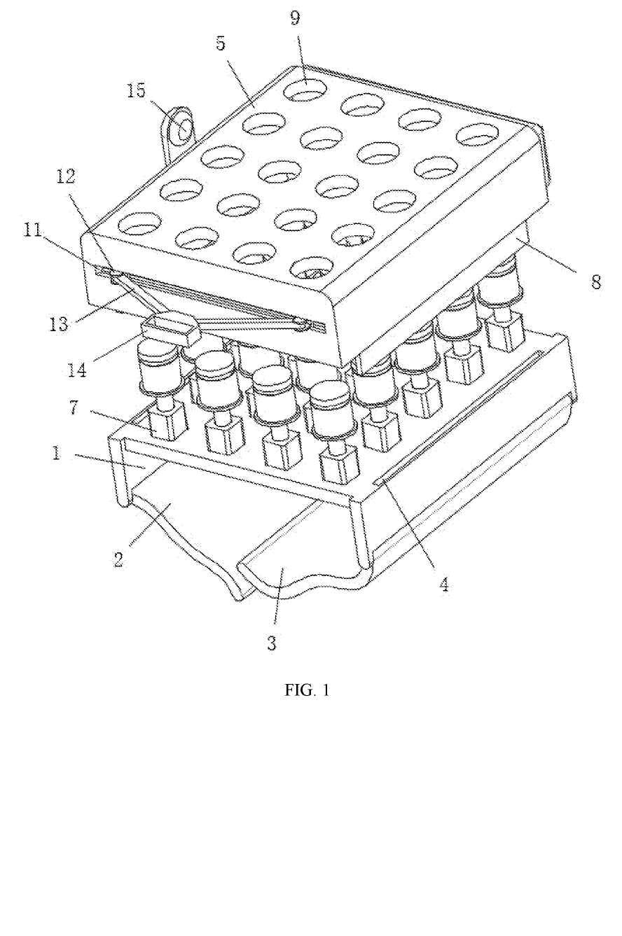

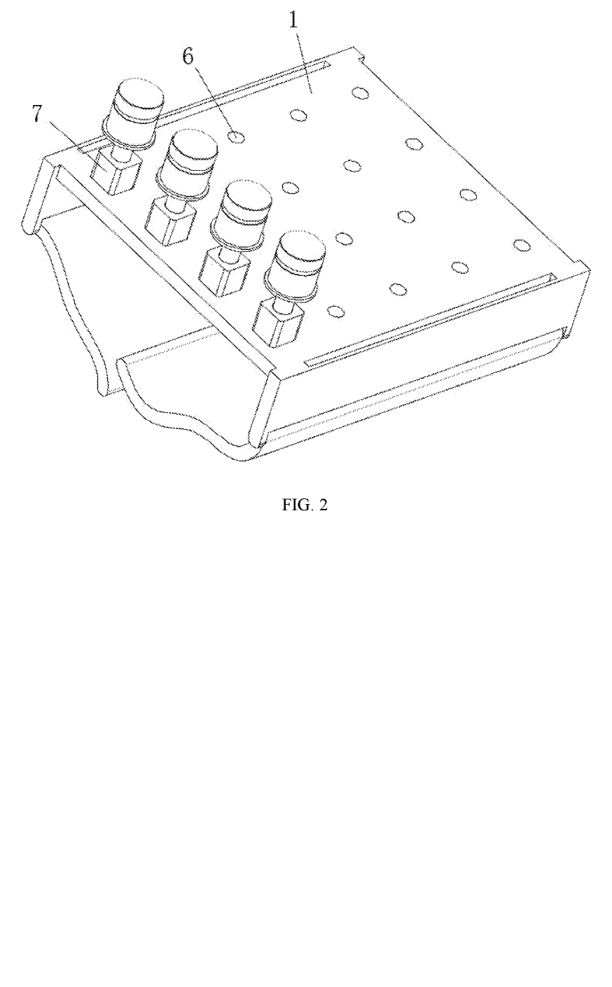

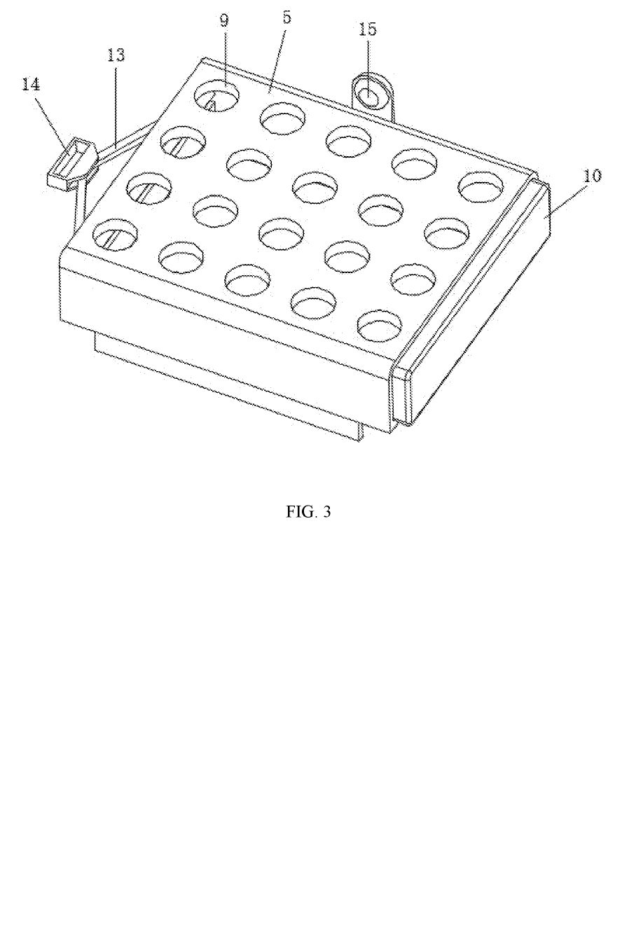

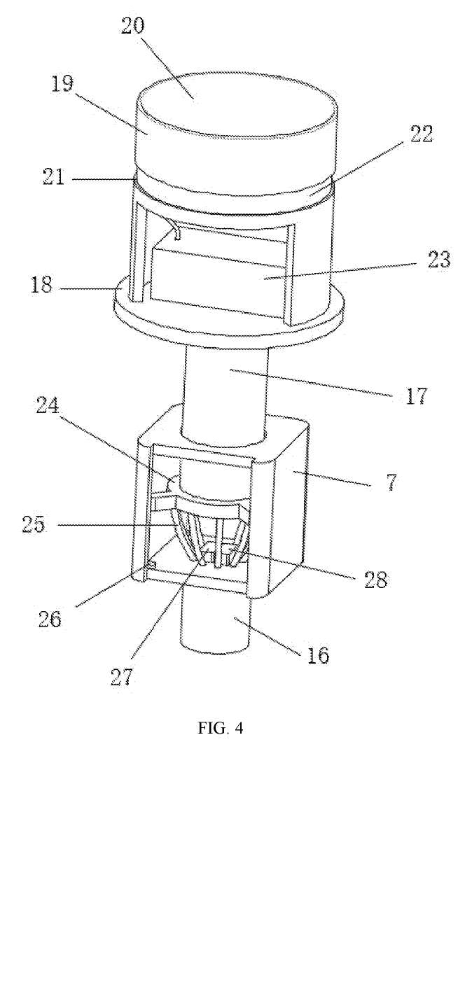

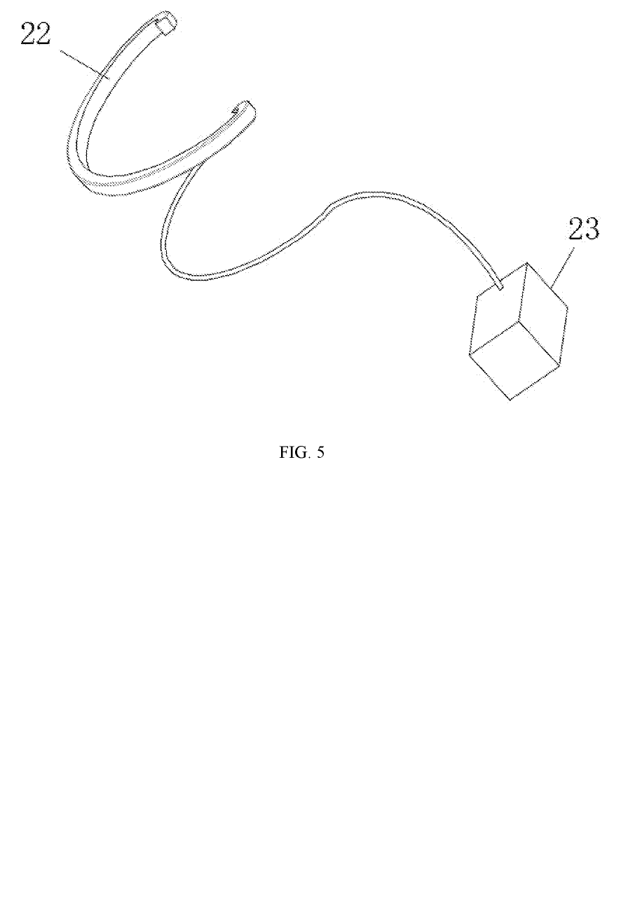

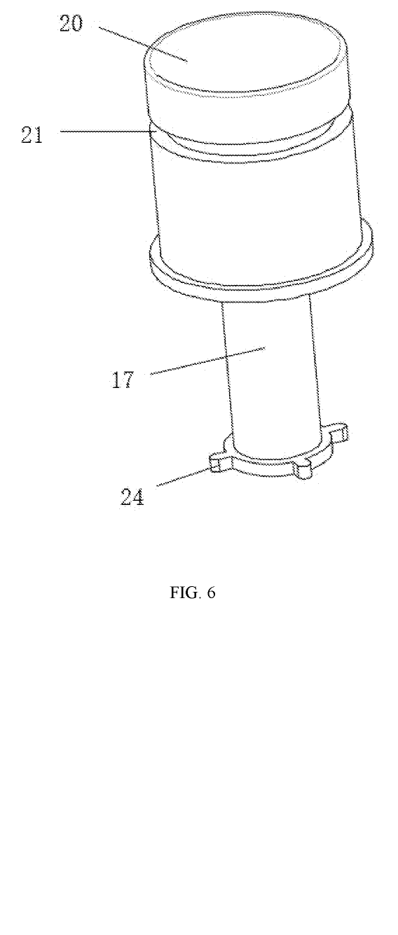

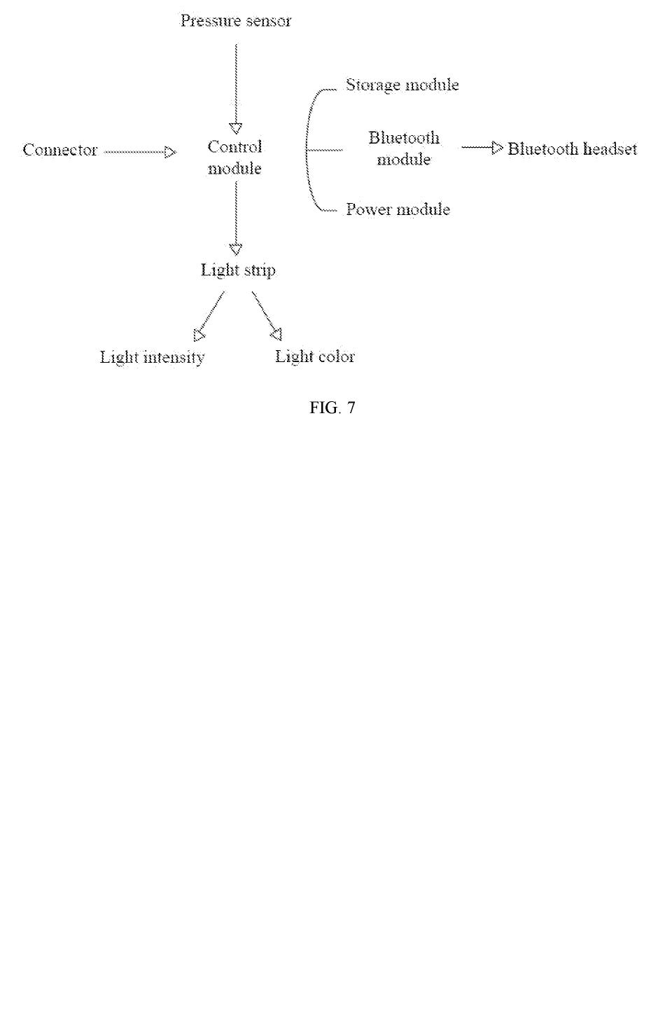

Referring to FIGS. 1-7, a practice device for violin fingering includes a base 1. A first adhesive sheet 2 and a second adhesive sheet 3 are rotatably mounted on two sides of a bottom end of the base 1, and an outer cover 5 is inserted at a top end of the base 1; the top end of the base 1 is disposed with sockets 6 in a rectangular array, and a buffer cover 7 is inserted at a top end of each of the sockets 6; a connector 27 and a pressure sensor 28 are fixedly mounted in a middle of an inner wall of a bottom end of the buffer cover 7, a support column 17 is slidably mounted at an interior of the buffer cover 7, and a top end of the support column 17 is fixedly connected to a limiting plate 18; a pressing cylinder 19 is fixedly mounted at a top end of the limiting plate 18, and a top end of the pressing cylinder 19 is arranged with a finger pressing groove 20; an annular opening 21 is disposed at an upper end of a circumference of the pressing cylinder 19, a control box 23 is placed at an interior of the pressing cylinder 19, a light strip 22 is wound around a circumference of the annular opening 21, and the light strip 22 is electrically connected to the control box 23 via a wire; and an outer wall of the outer cover 5 is sprayed with a magnetic coating, a recording box 10 is magnetically sucked on an outer wall of one end of the outer cover 5, a camera 15 is magnetically sucked on an outer wall of one side of the outer cover 5, a plurality of through holes 9 are disposed on a top end of the outer cover 5, and centers of the through holes 9 and the sockets 6 in each row are located on the same straight line.

In the present disclosure, rectangular grooves 4 are disposed on two sides of the top end of the base 1, rectangular sheets 8 are fixedly connected to two sides of a bottom end of the outer cover 5, and the rectangular sheet 8 on each side is inserted into the rectangular groove 4, which facilitates the connection and separation of the base 1 and the outer cover 5, and facilitates the replacement of the pressing cylinder 19 according to different finger practices.

A sliding groove 11 is disposed at a middle and upper end of an outer wall of the other end of the outer cover 5, and sliding blocks 12 are slidably mounted on two sides of an interior of the sliding groove 11; and guide rods 13 are rotatably mounted at the other ends of the two sliding blocks 12, and a mounting frame 14 is rotatably arranged at terminal ends of the two guide rods 13. In this way, the camera 15 can be placed on the mounting frame 14, and the mounting frame 14 can be pulled away from the outer cover 5, so that the camera 15 can more clearly photograph the force-generating state and positions of fingers when performing violin fingering practice. An outer side of the mounting frame 14 is made of a rubber material, so that the mounting frame 14 can be deformed, and two adjacent fingers can be split for practice.

An inserting column 16 is fixedly connected to the bottom end of the buffer cover 7, which facilitates the mounting of the buffer cover 7 on the top end of the base 1; and four corners of the buffer cover 7 are rounded, and rubber columns 26 are fixedly mounted at four corners of the bottom end of the buffer cover 7.

A pressing block 24 is fixedly connected to a bottom end of the support column 17, and four corners of the pressing block 24 are slidably sleeved with four corners of an inner wall of the buffer cover 7; and a plurality of elastic rods 25 with equal angles are fixedly and obliquely mounted between a bottom end of the pressing block 24 and an inner wall of the bottom end of the buffer cover 7, and the four rubber columns 26 are all located at bottom ends of the four corners of the pressing block 24. The plurality of elastic rods 25 help to cushion a downward movement speed of the pressing block 24 and the resetting of the pressing cylinder 19.

A diameter of the limiting plate 18 is large than that of the through hole 9, and the diameter of the through hole 9 is slightly larger than that of the pressing cylinder 19, so that the pressing cylinder 19 can extend and retract inside the through hole 9 without moving out.

A top end of the finger pressing groove 20 is rounded, and the finger pressing groove 20 is sprayed with a matte coating, which increases the comfort when the fingers are pressed, and prevents the fingers from turning red due to locally pressure by the top ends of the finger pressing grooves 20.

An interior of the control box 23 is arranged with a control module, a Bluetooth module, a power module and a storage module.

The light strip 22 is arranged with a light color change and a light intensity gradient.

The working principle is as follows. The buffer covers 7, the pressing cylinders 19 and the outer cover 5 are arranged at the top end of the base 1, and lower ends of circumferences of the pressing cylinders 19 are located at top ends of the buffer covers 7. Before performing violin fingering practice, firstly, the practice content of fingering is confirmed, and the base 1 is fixed on the violin through the first adhesive sheet 2 and the second adhesive sheet 3; sequentially, the split practice of two adjacent fingers is performed; and finally, the recording box 10 and the camera 15 are magnetically attracted to appropriate positions of the outer cover 5, and the violin fingering practice is performed. Moreover, the light strips 22 are arranged at the circumferences of the pressing cylinders 19, and the light strip 22 is arranged with a light color change and a light intensity gradient. The interior of the control box 23 is arranged with the control module, the Bluetooth module, the power module and the storage module. When fingertips press the finger pressing grooves 20 of the pressing cylinders 19, the light strips 22 of the pressing cylinders 19 illuminate, and as the pressing strength increases, colors of the light strips deepen and light becomes bright; and the camera 15 records bending angles of fingers, and the recording box 10 records the sound of pressing and knocking strength of the fingers, to help the practicer observe the force-generating state of fingers later, and perform targeted practice. If fingering practice is not performed according to an order of practice content or a practice error occurs, a light strip 22 of a pressing cylinder 19 which is not to be pressed sends a warning light.

The magnetic coating is sprayed on the outer wall of the outer cover 5, the recording box 10 is magnetically absorbed on the outer wall of one end of the outer cover 5, and the camera 15 is magnetically absorbed on the outer wall of one side of the outer cover 5. Positions of the recording box 10 and the camera 15 on the outer wall of the outer cover 5 can be adjusted according to requirements. The sliding groove 11 is disposed at the middle and upper end of the outer wall of the other end of the outer cover 5, and the sliding blocks 12 are slidably mounted on the two sides of the interior of the sliding groove 11; and the guide rods 13 are rotatably mounted at the other ends of the two sliding blocks 12, and the mounting frame 14 is rotatably arranged at the terminal ends of the two guide rods 13. In this way, the camera 15 can be placed on the mounting frame 14, and the mounting frame 14 can be pulled away from the outer cover 5, so that the camera 15 can more clearly photograph the force-generating state and positions of fingers when performing violin fingering practice. The outer side of the mounting frame 14 is made of a rubber material, so that the mounting frame 14 can be deformed, and two adjacent fingers can be split for practice.

The above is only the preferred examples of the present disclosure, but the scope of protection of the present disclosure is not limited to this. Within the technical scope disclosed by the present disclosure, any equivalent substitutions or changes made by those skilled in the art according to the technical solution and the inventive concept of the present disclosure are to be covered by the scope of protection of the present disclosure.

1. A practice device for violin fingering, comprising a base (1), wherein a first adhesive sheet (2) and a second adhesive sheet (3) are rotatably mounted on two sides of a bottom end of the base (1), and an outer cover (5) is inserted at a top end of the base (1); the top end of the base (1) is disposed with sockets (6) in a rectangular array, and a buffer cover (7) is inserted at a top end of each of the sockets (6); a connector (27) and a pressure sensor (28) are fixedly mounted in a middle of an inner wall of a bottom end of the buffer cover (7), a support column (17) is slidably mounted at an interior of the buffer cover (7), and a top end of the support column (17) is fixedly connected to a limiting plate (18); a pressing cylinder (19) is fixedly mounted at a top end of the limiting plate (18), and a top end of the pressing cylinder (19) is arranged with a finger pressing groove (20); an annular opening (21) is disposed at an upper end of a circumference of the pressing cylinder (19), a control box (23) is placed at an interior of the pressing cylinder (19), a light strip (22) is wound around a circumference of the annular opening (21), and the light strip (22) is electrically connected to the control box (23) via a wire; and an outer wall of the outer cover (5) is sprayed with a magnetic coating, a recording box (10) is magnetically sucked on an outer wall of one end of the outer cover (5), a camera (15) is magnetically sucked on an outer wall of one side of the outer cover (5), a plurality of through holes (9) are disposed on a top end of the outer cover (5), and centers of the through holes (9) and the sockets (6) in each row are located on the same straight line.

2. The practice device for violin fingering according to claim 1, wherein rectangular grooves (4) are disposed on two sides of the top end of the base (1), rectangular sheets (8) are fixedly connected to two sides of a bottom end of the outer cover (5), and the rectangular sheet (8) on each side is inserted into the rectangular groove (4).

3. The practice device for violin fingering according to claim 1, wherein a sliding groove (11) is disposed at a middle and upper end of an outer wall of the other end of the outer cover (5), and sliding blocks (12) are slidably mounted on two sides of an interior of the sliding groove (11); and guide rods (13) are rotatably mounted at the other ends of the two sliding blocks (12), and a mounting frame (14) is rotatably arranged at terminal ends of the two guide rods (13), an outer side of the mounting frame (14) being made of a rubber material.

4. The practice device for violin fingering according to claim 1, wherein an inserting column (16) is fixedly connected to the bottom end of the buffer cover (7), four corners of the buffer cover (7) are rounded, and rubber columns (26) are fixedly mounted at four corners of the bottom end of the buffer cover (7).

5. The practice device for violin fingering according to claim 4, wherein a pressing block (24) is fixedly connected to a bottom end of the support column (17), and four corners of the pressing block (24) are slidably sleeved with four corners of an inner wall of the buffer cover (7); and a plurality of elastic rods (25) with equal angles are fixedly and obliquely mounted between a bottom end of the pressing block (24) and an inner wall of the bottom end of the buffer cover (7), and the four rubber columns (26) are all located at bottom ends of the four corners of the pressing block (24).

6. The practice device for violin fingering according to claim 1, wherein a diameter of the limiting plate (18) is large than that of the through hole (9), and the diameter of the through hole (9) is slightly larger than that of the pressing cylinder (19).

7. The practice device for violin fingering according to claim 1, wherein a top end of the finger pressing groove (20) is rounded, and the finger pressing groove (20) is sprayed with a matte coating.

8. The practice device for violin fingering according to claim 1, wherein an interior of the control box (23) is arranged with a control module, a Bluetooth module, a power module and a storage module.

9. The practice device for violin fingering according to claim 1, wherein the light strip (22) is arranged with a light color change and a light intensity gradient.
